(19) United States
(12) Patent Application Publication
(10) Pub. No.: US 2004/0207256 A1
(43) Pub. Date: Oct. 21, 2004

(54) Electrohydraulic unit

(76) Inventor: Peter Volz, Darmstadt (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/485,168

(22) PCT Filed: Jul. 26, 2002
(86) PCT No.: PCT/EP02/08364

(51) Int. Cl. B60T 8/36

(52) U.S. Cl. 303/119.3; 303/DIG. 10

(57) ABSTRACT

An electrohydraulic unit including a hydraulic unit comprising an accommodating member that accommodates electrically actuatable valves and a hydraulic pump, an electric driving device for the pump, and a pressure fluid accumulator fed by the pump and including a media separating element and a sensor device including a receiving element for monitoring the position of the media separating element, and including an electronic unit for the electronic actuation of the valves and the driving device and for receiving electric signals of the sensor device. The sensor device is arranged in the accommodating member or in the electronic unit. An electrical connection is established between sensor device and electronic unit within the unit. This economizes mounting space and enables improved electrical connection.

### TECHNICAL FIELD

The present invention generally relates to an electrohydraulic control unit and more particularly relates to an electrohydraulic unit, in particular for slip-controlled motor vehicle brake systems.

### BACKGROUND OF THE INVENTION

An unit of this general type is disclosed in international publication WO 99/41125 and allows for the detection of gas or air disposed in the hydraulic part of the unit which may cause power loss of the system due to compressibility.

German application DE 100 18 189 A1 discloses a pressure fluid accumulator for use in an electrohydraulic unit. The pressure fluid accumulator has a sensor device that is arranged in the gas chamber bounded by the media separating element in the housing and permits adapting a pressure/volume characteristic curve. The arrangement requires carefully sealing electric contact elements of the sensor device in relation to the ambience. The overall size of an electrohydraulic unit equipped with the prior art pressure fluid accumulator is considered as needing improvement.

### BRIEF SUMMARY OF THE INVENTION

An object of the present invention is to provide an electrohydraulic unit permitting a reduction of the available mounting space in a motor vehicle. Another objective is to reduce the overall size of the unit, in particular the high-pressure accumulator.

According to the invention, this object is achieved in that the sensor device is arranged in the electronic unit or in the hydraulic unit, and in that an electrical connection is established between sensor device and electronic unit within the unit. The invention permits reducing the overall dimensions of the unit because the space available in the electronic unit or the hydraulic unit is utilized. This consequently reduces the necessary mounting space in the vehicle and, more particularly, reduces the mounting space needed for the high-pressure accumulator. The invention makes electrical contacting between sensor device and electronic unit possible that is protected against mechanical damage.

According to a favorable embodiment of the invention, the electrical connection between electronic unit and sensor device is provided in parallel to a plug for the purpose of electrical supply of the driving device. This enables a uniform plane of assembly for joining driving device, pressure fluid accumulator, accommodating member and electronic unit.

In another favorable embodiment of the invention, the electrical connection of the sensor device extends through the accommodating member. This protects the electrical connection, diminishing the influence of electromagnetic disturbances that act from outside.

The space required for the sensor device is minimized when a sensing element of the sensor device is guided and arranged in a hydraulic connection between pressure fluid accumulator and accommodating member so as to be displaceable synchronously with the media separating element. This is because the absolutely necessary connection is also used to accommodate the sensing element. A low-cost arrangement of bores in the accommodating member is achieved when the hydraulic connection is provided in parallel to a bore for the plug. This applies in particular when the hydraulic connection is also provided in parallel to a pump bore.

Advantageously, the sensing element is arranged in a sleeve that is pressure-tightly fastened to the accommodating member and extends into the area of the housing of the electronic unit. Said sleeve has a cup-shaped design, i.e. it is closed on one side, and quasi extends a hydraulic connection accepting a sensing element of the sensor device up to an inner space of the housing.

In another embodiment of the invention, the sensor device includes a receiving element being arranged in a sleeve, the open end of said sleeve being pressure-tightly connected to the accommodating member, and with said sleeve defining the chamber of the pressure fluid accumulator.

To effectively utilize the available space, the electric driving device and the pressure fluid accumulator are arranged on one side of the accommodating member and diagonally opposite each other.

### BRIEF DESCRIPTION OF THE DRAWINGS

FIG. 1 is a first embodiment of an electrohydraulic unit.

FIG. 2 is a second embodiment of an electrohydraulic unit.

FIG. 3 is a third embodiment of an electrohydraulic unit.

FIG. 4 is a fourth embodiment of an electrohydraulic unit.

FIG. 5 is a fifth embodiment of an electrohydraulic unit.

### DETAILED DESCRIPTION OF THE PREFERRED EMBODIMENTS

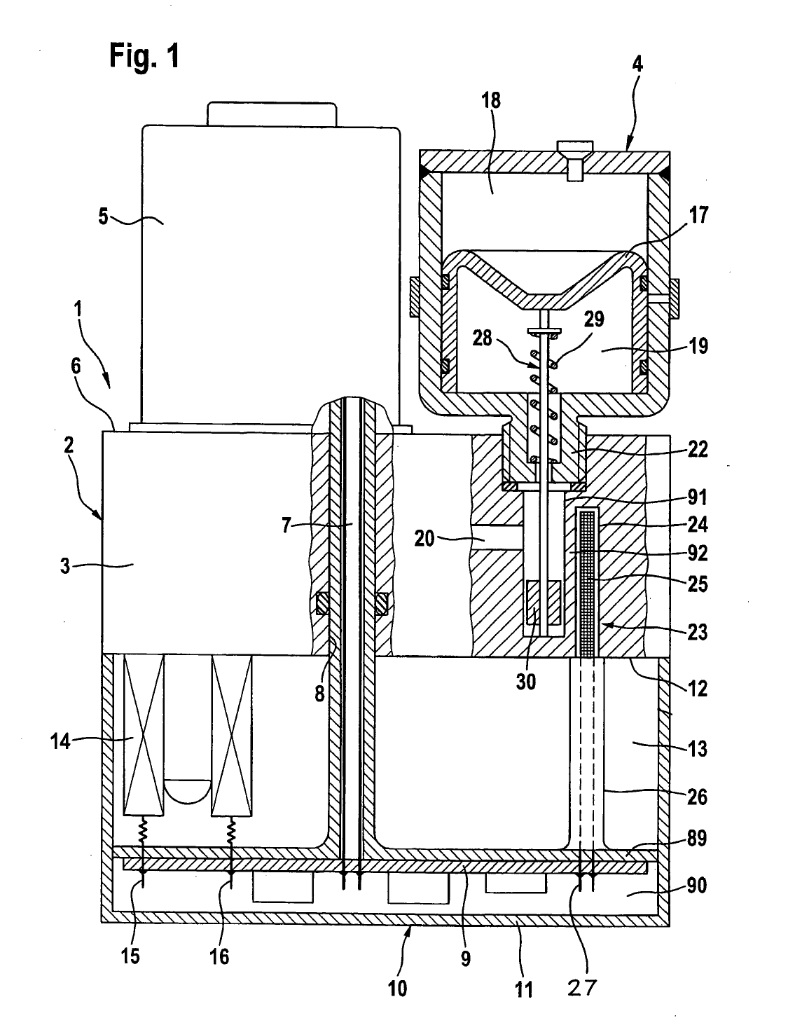

FIG. 1 is a greatly simplified view of an electrohydraulic unit 1 for hydraulic motor vehicle brake devices. Unit 1 comprises a hydraulic unit 2 with an accommodating member 3 for a hydraulic pump (not shown) comprising a pump bore and, preferably, pump pistons for feeding a pressure fluid accumulator 4 that is pressure-tightly attached to the accommodating member 3 and provided for the pressure supply of an electronically operated brake system of the brake-by-wire type. It is principally possible to use an internal geared wheel pump as the pump, what can contribute to further mounting space reduction. An electric driving device 5 is connected mechanically to the pump and fastened to a first side 6 of the accommodating member 3. Pressure fluid accumulator 4 and driving device 5 are arranged paraxially relative to each other and diagonally opposite each other on side 6. A plug 7 with electric conductors for the electrical supply of the driving device 5 extends through a bore 8 in the accommodating member 3 and, for the purpose of current supply, contacts a printed circuit board assembly 9 of an electronic unit 10, whose housing 11 is attached to a second side 12 of the accommodating member 3 and along with said confines an inner space 13. In addition, a bottom 89 is provided in housing 11 to separate the inner space 13 fluid-tightly from a hollow space 90 wherein basically the printed circuit board assembly 9 with electronic components is disposed. Bottom 89 is also used to fasten the printed circuit board assembly 9 to housing 11. As FIG. 1 shows by way of example, one electromagnetic coil 14 (of principally several coils) of a hydraulic valve is connected to the printed circuit board assembly 9 by way of connecting wires 15, 16 and projects into the inner space 13 through which plug 7 extends. Connecting wires 15, 16 allow both an electrical connection and a quasi mechanically flexible coupling to the printed circuit board assembly 9.

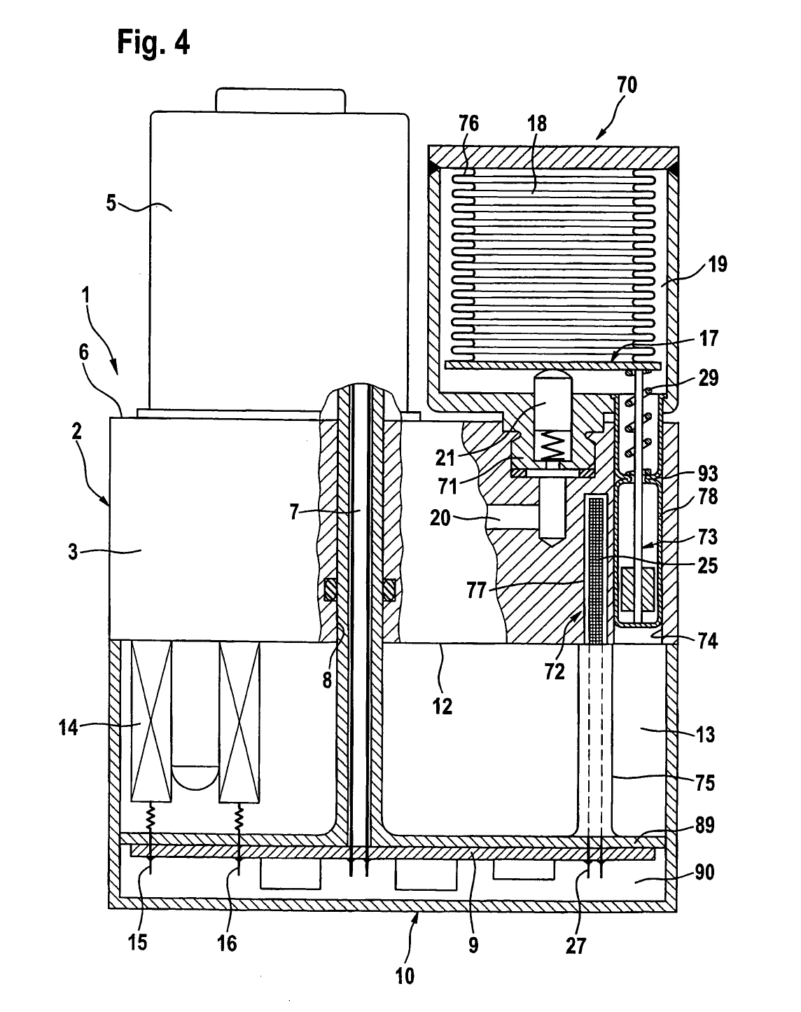

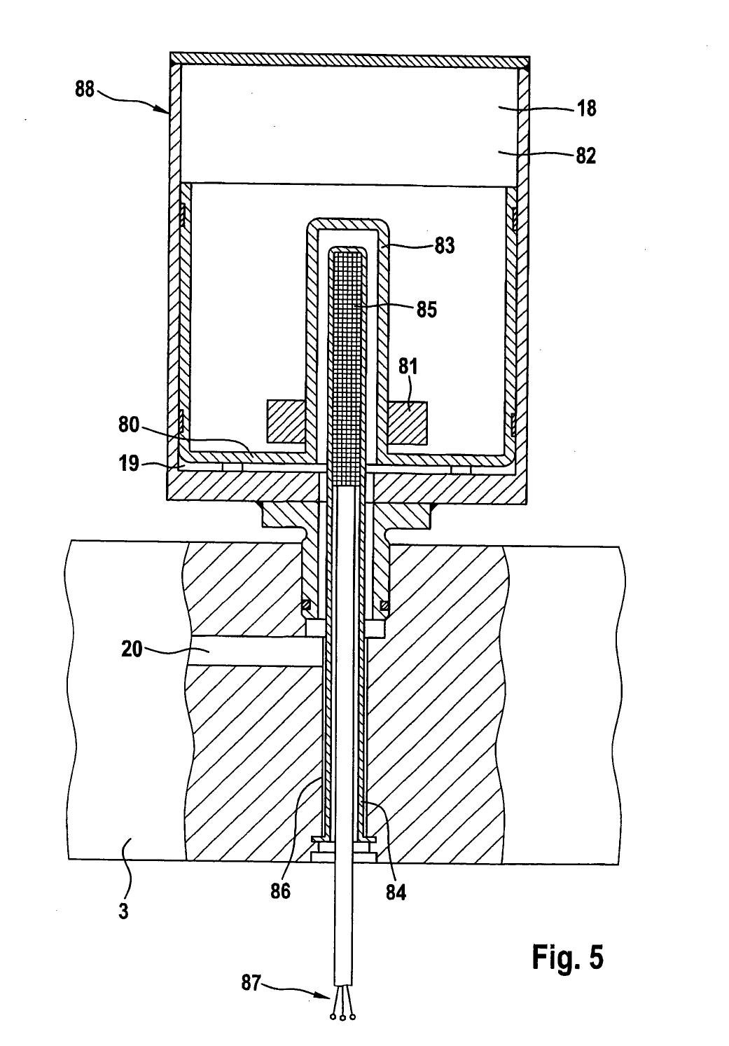

Pressure fluid accumulator 4, which is exemplarily configured as a piston-type accumulator but may basically also be designed as a diaphragm-type accumulator or metal pleated-bellows accumulator, comprises a media separating element 17 separating a first chamber 18 filled with compressed gas from a second chamber 19 filled with pressure fluid. The second chamber 19 is connectable to the pump by means of hydraulic connections 20, one of which is only indicated in the drawing, or to wheel brakes by way of the interposed valves. The pressure fluid accumulator 4 can dispose of a valve 21 centrically arranged in a bottom area and preventing excessive evacuation by passing over into a closed position when a defined level in the accumulator is reached (FIG. 4). Preferably, valve 21 is controlled mechanically by the media separating element 17 approaching the bottom. Valve 21 can further be replaced by a valve element arranged annularly at the media separating element 80 (as shown in FIG. 5) or by an equally acting means without departing from the spirit of the invention.

Adjacent to the bottom area is a substantially tubular socket 22 provided with an external thread that can be screwed into an internally threaded bore in the accommodating member 3. The tubular socket 22 is further used to hydraulically connect chamber 19 to the connection 20.

The position of the media separating element 17 is monitored for the detection of compressibilities in the brake system. A sensor device 23 is provided for this purpose, the electric part of which is arranged in a recess in the accommodating member 3 in the embodiments according to FIGS. 1, 2, 4 and 5. According to FIG. 5, the electric part of the sensor device is provided within the pressure fluid accumulator 88, however, separated from chamber 19 by a sleeve 84.

As is shown in FIG. 1, the accommodating member 3 includes a blind-hole-type recess 24 devoid of pressure fluid, open towards side 12 and arranged in parallel to bore 8 for the plug 7. An electric receiving element 25 of sensor device 23 is arranged in recess 24. Receiving element 25 is provided at the end of a spacer 26 between printed circuit board arrangement 9 and recess 24. Said spacer 26 is generally stiff and extends through the inner space 13 accepting electric conductors whose end 27 is electrically connected to the printed circuit board assembly 9. A sensing element 28 of sensor device 23 has a rod-shaped design and is incorporated in a bore 91 of accommodating member 3 that is separated from recess 24 by a thin wall 92. A spring element 29 is elastically preloaded between a step of socket 22 and a projection of sensing element 28 so that the latter is urged in the direction of the media separating element 17. This renders the sensing element 28 together with the media separating element 17 displaceable relative to the receiving element 25 fixed in the accommodating member 3. At the end of sensing element 28 close to the receiving element, there is a sensing member 30 cooperating with receiving element 25 for the generation of signals. Various principles may basically be used for the sensor device 23 so that e.g. a coil/armature assembly may be employed.

As is illustrated, receiving element 25 along with spacer 26 and coil 14 is in electrical contact with and mechanically attached to the printed circuit board assembly 9 of the electronic unit 10. For the final assembly, the entire electronic unit 10 with coil 14 suspended in an elastical and tolerance-compensating fashion and with receiving element 25 is slid in the direction of accommodating member 3 and fastened. Additionally, there is electrical contacting of interfaces (electric/magnetic plug). The driving device 5 is shifted in the direction of accommodating member 3 on side 6. When the plug 7 is arranged at the driving device 5, it is pushed through bore 8 into a recess in the area of the printed circuit board assembly 9 for electrical contacting. It is principally also possible to fix plug 7 at bottom 89, as shown in FIG. 1, with the contacting with the printed circuit board assembly 9 being prefabricated. This achieves a plug connection close to the driving device in the area of an engine end plate (not shown) or in the area of a brush holding plate.

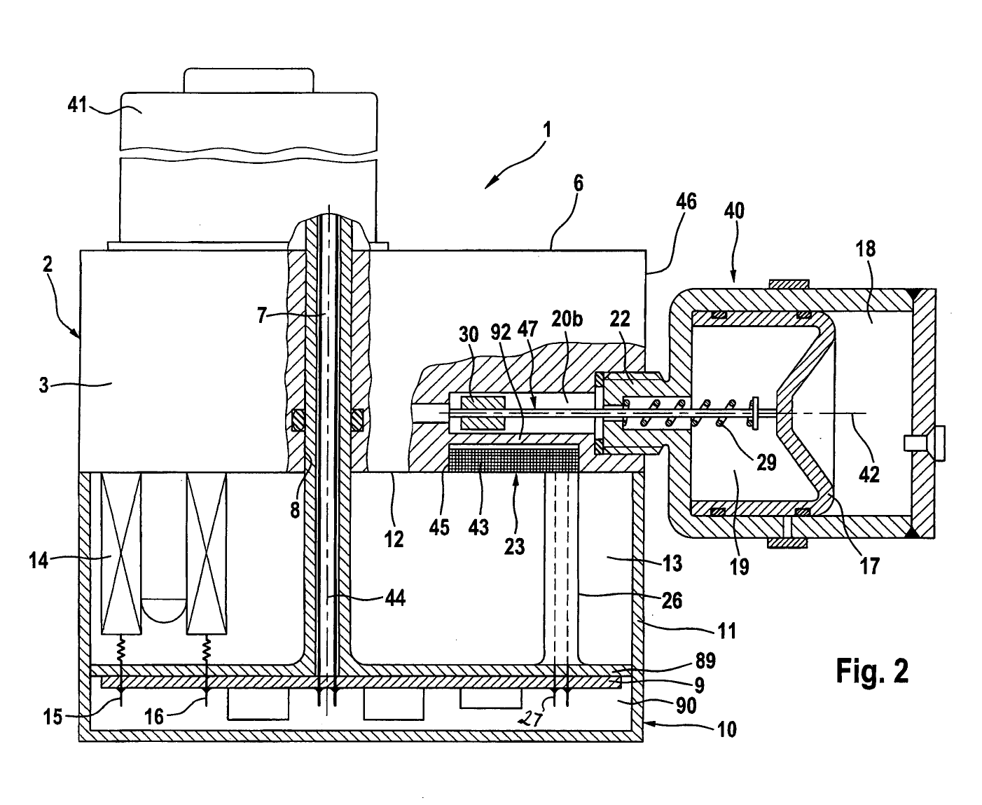

The embodiment of FIG. 2 corresponds generally to the embodiment of FIG. 1, and equal reference numerals have been assigned to equal components. Different from FIG. 1, a pressure fluid accumulator 40 is not arranged along with a driving device 41 on a side 6 of the accommodating member 3 but is arranged on another side 46 displaced by 90°. Accordingly, a displacement axis 42 of sensing element 47 is offset by 90° relative to an axis 44 of plug 7. Arranged in a recess 45 in the accommodating member 3 is a receiving element 43 of a sensor device 23 that corresponds mainly with FIG. 1. Receiving element 43 is provided at one end 27 of spacer 26 and deviated by 90° relative to said so that it can be inserted into recess 45. A sensing element 47 is disposed in a hydraulic connection 20b, which extends in parallel to a pump bore (not shown) and at right angles relative to an accommodating bore for the driving device 41 and at right angles relative to bore 8. The assembly and electrical contacting of the construction units is as described relating to FIG. 1.

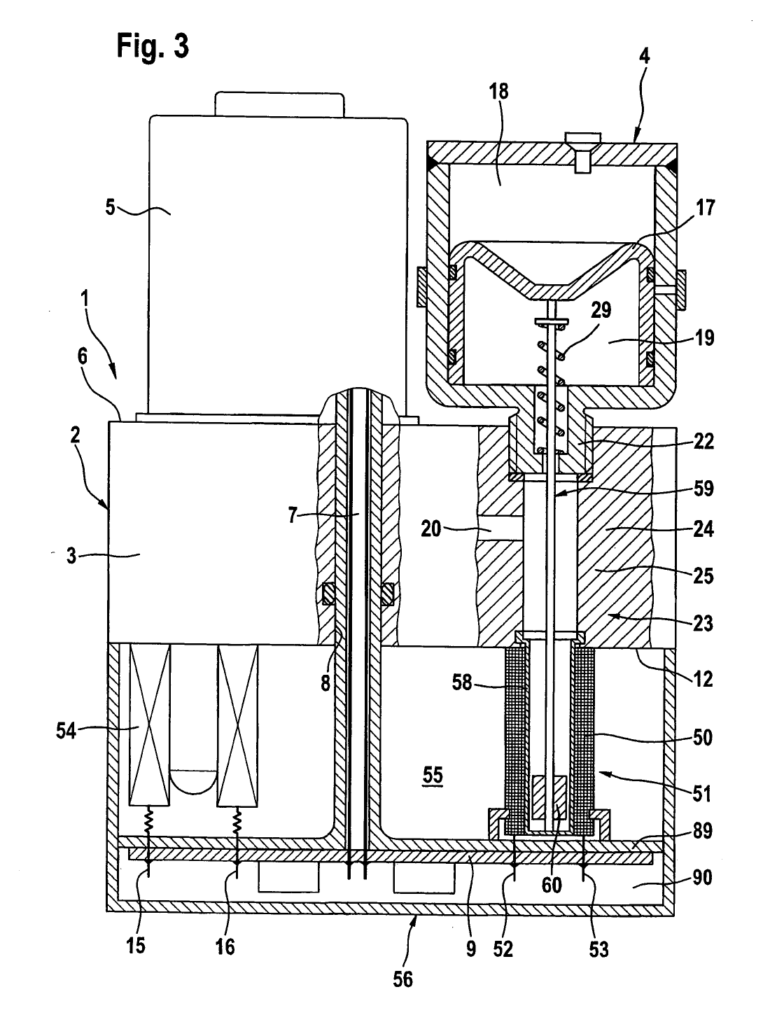

According to FIG. 3, a receiving element 50 of a sensor device 51 is connected electrically to the printed circuit board assembly 9 by means of electric conductors 52, 53. Receiving element 50 is e.g. an annular coil which, comparable with coil 54 of a valve, extends into a recess 55 within an electronic unit 56. A housing 57 and side 12 of the accommodating member 3 confine recess 55. No spacer is needed for the connection of receiving element 50. A sensing element 59 of sensor device 51 has a longer design compared to FIG. 1 and extends completely through accommodating member 3 and at least partly through recess 55 so that signals for detecting the position of the media separating element 17 are generated due to translation of a component 60 of sensing element 59 in relation to receiving element 50. Sensing element 59 is encompassed by pressure fluid as can be seen in FIG. 3. A bowl-shaped cylindrical sleeve 58 that is calked with an open end into the accommodating member 3 in a fluid-tight manner is used to seal the high-pressure area.

An embodiment of FIG. 4 comprises a centrically arranged valve 21 in the bottom area of a media separating element 17 that includes a metal pleated bellows 76. Because valve 21 has a compact body that is centrically arranged in the area of a tubular socket 71, a sensor device 72 is not arranged centrically relative to the pressure fluid accumulator 70 as in FIG. 3 but quasi off-center in a recess 77 of the accommodating member 3. Beside recess 77 another bore 74 is provided into which a bowl-shaped sleeve 78 is slid to accept a sensing element 73. The bowl-shaped sleeve 78 is attached fluid-tightly to the pressure fluid accumulator 70 and opens with an open end into chamber 19. Sleeve 78 disposes of a stop 93 for spring element 29. The electrical connection of sensor device 72 is via a spacer 75 as described with respect to FIG. 1.

The embodiment according to FIG. 5 includes a sensing element 81 fixed to a media separating element 80 and arranged within a pressure fluid accumulator 88. Said media separating element 80 has a centrically arranged bowl 83, open on one side and retracted in the direction of a first chamber 82. Accommodating member 3 includes a bore 86 into which a sleeve 84 is pressure-tightly inserted to accept receiving element 85. Sensing element 81 is slidable along with media separating element 80 in relation to receiving element 85 that is slid into sleeve 84. Electric conductors 87 are used for the electrical connection, extending through sleeve 84 in the accommodating member 3 and through a recess in an electronic unit (not shown) up to a printed circuit board assembly (not shown). A spacer between printed circuit board assembly and receiving element 85 will bring about the necessary mechanical stability and simplification of the assembly.

It is essential that the invention not only permits reduction of the overall dimensions but also a consequent division of labor during manufacture by making a distinction between the hydraulic/mechanical fabrication in the area of the accommodating member and the electric/mechanical equipment and fabrication in the area of the printed circuit board assembly. The subassemblies relating to electronic unit, accommodating member, driving device and pressure fluid accumulator may be assembled in a quasi plug-in type fashion. The electric connection system is arranged inside the unit and guided through the electronic unit and, optionally, through the accommodating member.

### List of Reference Numerals

1 unit

2 hydraulic unit

3 accommodating member

4 pressure fluid accumulator

5 driving device

6 side

7 plug

8 bore

9 printed circuit board assembly

10 electronic unit

11 housing

12 side

13 inner space

14 coil

15 connecting wire

16 connecting wire

17 media separating element

18 chamber

19 chamber

20,20b connection

21 valve

22 socket

23 sensor device

24 recess

25 receiving element

26 spacer

27 end

28 sensing element

29 spring element

30 sensing member

40 pressure fluid accumulator

41 driving device

42 displacement axis

43 receiving element

44 axis

45 recess

46 side

47 sensing element

50 receiving element

51 sensor device

52 conductor

53 conductor

54 coil

55 recess

56 electronic unit

57 housing

58 sleeve

59 sensing element

70 pressure fluid accumulator

71 socket

72 sensor device

73 sensing element

74 bore

75 spacer

76 metal pleated bellows

77 recess

78 sleeve

80 media separating element

81 sensing element

82 chamber

83 bowl

84 sleeve

85 receiving element

86 bore

87 conductor

88 pressure fluid accumulator

89 bottom

90 hollow space

91 bore

92 wall

93 stop

1.-9. (canceled)

10. Electrohydraulic unit, comprising:
a hydraulic unit including an accommodating member that accommodates electrically actuatable valves and a hydraulic pump,
an electric driving device for the pump,
a pressure fluid accumulator fed by the pump and associated with said fluid accumulator is a media separating element and a sensor device including a receiving element for monitoring the position of the media separating element, and
an electronic unit for the electronic actuation of the valves and the driving device and for receiving electric signals of the sensor device, wherein the sensor device is arranged in the electronic unit or in the hydraulic unit, and wherein an electrical connection is established between sensor device and electronic unit within the unit.

11. Electrohydraulic unit as claimed in claim 10, wherein the electrical connection is provided in parallel to a plug for the purpose of electrical supply of the driving device.

12. Electrohydraulic unit as claimed in claim 10, wherein the electrical connection extends through the accommodating member.

13. Electrohydraulic unit as claimed in claim 10, wherein a sensing element is guided and arranged in a hydraulic connection between pressure fluid accumulator and accommodating member, wherein said sensing element is displaceable synchronously with the media separating element.

14. Electrohydraulic unit as claimed in claim 13, wherein the hydraulic connection is provided in parallel to a bore for the plug.

15. Electrohydraulic unit as claimed in claim 13, wherein the hydraulic connection is provided in parallel to a pump bore.

16. Electrohydraulic unit as claimed in claim 13, wherein the sensing element is arranged in a sleeve that is fastened to the accommodating member.

17. Electrohydraulic unit according to claim 10, wherein the sensor device is arranged in the pressure fluid accumulator and includes a receiving element that is arranged in a sleeve, wherein an open end of said sleeve is pressure-tightly connected to the accommodating member, and wherein the sleeve bounds the chamber of the pressure fluid accumulator.

18. Electrohydraulic unit as claimed in claim 10, wherein the electric driving device and the pressure fluid accumulator are arranged on one side of the accommodating member and diagonally opposite each other.
